(19) United States
(12) Patent Application Publication
(10) Pub. No.: US 2007/0075554 A1
(43) Pub. Date: Apr. 5, 2007

(54) Hood strut assembly and method of mounting hood strut assembly to a vehicle body and a vehicle hood

(76) Inventor: Nicholas J. Gavriles, Novi, MI (US)

Correspondence Address: CANTOR COLBURN, LLP, 55 GRIFFIN ROAD SOUTH, BLOOMFIELD, CT, 06002, US

(21) Appl. No.: 11/504,901

(22) Filed: Aug. 16, 2006

Related U.S. Application Data
(60) Provisional application No. 60/721,627, filed on Sep. 30, 2005.

(51) Int. Cl. E05C 17/54

(52) U.S. Cl. 292/339

(57) ABSTRACT

A hood strut assembly and a method for mounting the hood strut assembly to a vehicle body and a vehicle hood are provided. The hood strut assembly utilizes a hood bracket, a body bracket, and a gas strut coupled between the hood bracket and the body bracket. The hood bracket has first and second plate portions and a first mounting member. The first plate portion extends from the second plate portion such that a predetermined angle is formed between the first plate portion and the second plate portion. The first plate portion has an end with a slot extending therethrough. The first plate portion further includes a first aperture extending therethrough. The first aperture is configured to receive a first fastener therethrough for coupling the hood bracket to a vehicle hood and the first slot configured to receive a second fastener therethrough for further coupling the hood bracket to the vehicle hood.

### CROSS REFERENCE TO RELATED APPLICATIONS

The application claims the benefit of U.S. Provisional application, ser. No. 60/721,627, filed Sep. 30, 2005, the contents of which are incorporated herein by reference thereto.

### BACKGROUND OF THE INVENTION

Hood struts have been utilized to assist operators in opening a vehicle hood. However, a problem associated with installing the hood struts is that several of the bolts attached to a hood must be removed prior to the hood strut being installed. Accordingly, the head strut is relatively difficult to install and undesirable movement of the hood can occur during installation.

Accordingly, the inventors herein have recognized a need for an improved hood strut that eliminates and or minimizes the above-mentioned problem.

### BRIEF DESCRIPTION OF THE INVENTION

A hood strut assembly in accordance with an exemplary embodiment is provided. The hood strut assembly includes a gas strut having a housing, a piston extending from the housing, and first and second attachment members. The first attachment member is coupled to the housing. The second attachment member is coupled to an end of the piston. The hood strut assembly further includes a hood bracket having first and second plate portions and a first mounting member. The first plate portion extends from the second plate portion such that a predetermined angle is formed between the first plate portion and the second plate portion. The first plate portion has an end with a slot extending therethrough. The first plate portion further includes a first aperture extending therethrough. The first aperture is configured to receive a first fastener therethrough for coupling the hood bracket to a vehicle hood and the first slot configured to receive a second fastener therethrough for further coupling the hood bracket to the vehicle hood. The first mounting member of the hood bracket is coupled to the first attachment member of the gas strut. The hood strut assembly further includes a body bracket configured to be coupled to a vehicle body. The body bracket has a second mounting member coupled to the second attachment member of the gas strut.

A hood strut assembly kit in accordance with another exemplary embodiment is provided. The hood strut assembly kit includes a first hood strut assembly having a first gas strut, a first hood bracket, and a first body bracket. The first gas strut has a first housing, a first piston extending from the first housing, and first and second attachment members. The first attachment member is coupled to the first housing. The second attachment member is coupled to an end of the first piston. The first hood bracket has first and second plate portions and a first mounting member. The first plate portion extends from the second plate portion such that a predetermined angle is formed between the first plate portion and the second plate portion. The first plate portion has an end with a first slot extending therethrough. The first plate portion further includes a first aperture extending therethrough. The first aperture is configured to receive a first fastener therethrough for coupling the first hood bracket to a vehicle hood and the first slot configured to receive a second fastener therethrough for further coupling the first hood bracket to the vehicle hood. The first mounting member of the first hood bracket is coupled to the first attachment member of the first gas strut. The first body bracket is configured to be coupled to a vehicle body. The first body bracket has a second mounting member coupled to the second attachment member of the first gas strut. The hood strut assembly kit further includes a second hood strut assembly having a second gas strut, a second hood bracket, and a second body bracket. The second gas strut has a second housing, a second piston extending from the second housing, and third and fourth attachment members. The third attachment member is coupled to the second housing. The fourth attachment member is coupled to an end of the first piston. The second hood bracket has third and fourth plate portions and a third mounting member. The third plate portion extends from the fourth plate portion such that a second predetermined angle is formed between the third plate portion and the fourth plate portion. The third plate portion has an end with a second slot extending therethrough. The third plate portion further includes a second aperture extending therethrough. The second aperture is configured to receive a third fastener therethrough for coupling the hood bracket to the vehicle hood and the second slot configured to receive a fourth fastener therethrough for further coupling the second hood bracket to the vehicle hood. The third mounting member of the second hood bracket being coupled to the third attachment member of the second gas strut. The second body bracket is configured to be coupled to the vehicle body. The second body bracket has a fourth mounting member coupled to the fourth attachment member of the second gas strut.

A method for mounting a hood strut assembly to both a vehicle body and a vehicle hood in accordance with another exemplary embodiment is provided. The hood strut assembly has a gas strut, a hood bracket, and a body bracket. The gas strut has a housing, a piston extending from the housing, and first and second attachment members. The first attachment member is coupled to the housing. The second attachment member is coupled to an end of the piston. The hood bracket has first and second plate portions and a first mounting member. The first plate portion extends from the second plate portion such that a predetermined angle is formed between the first plate portion and the second plate portion. The first plate portion has an end with a slot extending therethrough. The first plate portion further includes a first aperture extending therethrough. The body bracket has a second mounting member. The method includes loosening a first fastening member coupled to the vehicle hood. The method further includes removing a second fastening member coupled to the vehicle hood. The method further includes moving the hood bracket such that the first fastening member is disposed in the slot of the hood bracket. The method further includes inserting the second fastening member through the first aperture of the hood bracket into an aperture of the hood. The method further includes engaging the first fastening member against the hood bracket to fixedly couple the hood bracket to the vehicle hood. The method further includes engaging the second fastening member against the hood bracket to further fixedly coupled the hood bracket to the vehicle hood. The method further includes inserting the third fastening member through the third aperture of the body bracket into an aperture of the vehicle body. The method further includes engaging the third fastening member against the body bracket to fixedly couple the body bracket to the vehicle body. The method further includes coupling the first mounting member of the hood bracket to the first attachment member of the gas strut. The method further includes coupling the second mounting member of the body bracket to the second attachment member of the gas strut.

### BRIEF DESCRIPTION OF THE DRAWINGS

FIG. 1 is a schematic of a first hood strut assembly of a hood strut assembly kit coupled between a vehicle hood and a vehicle body, in accordance with an exemplary embodiment;

FIG. 2 is a schematic of a second hood strut assembly of the hood strut assembly kit coupled between the vehicle hood and the vehicle body, in accordance with another exemplary embodiment;

FIGS. 3-5 are schematics of a hood bracket utilized in the first hood strut assembly of FIG. 1;

FIGS. 6-8 are schematics of a hood bracket utilized in the second hood strut assembly of FIG. 2;

FIG. 9 is a schematic of a body bracket utilized in the first hood strut assembly of FIG 1;

FIG. 10 is a schematic of a body bracket utilized in the second hood strut assembly of FIG. 2;

FIG. 11 is a gas strut utilized in the second hood strut assembly of FIG. 2;

FIG. 12 is a schematic of the body bracket of FIG. 9 coupled to a vehicle body; and

FIGS. 13-14 are flowcharts of a method for mounting a hood strut assembly to both the vehicle body and a vehicle hood in accordance with another exemplary embodiment.

### DETAILED DESCRIPTION OF THE INVENTION

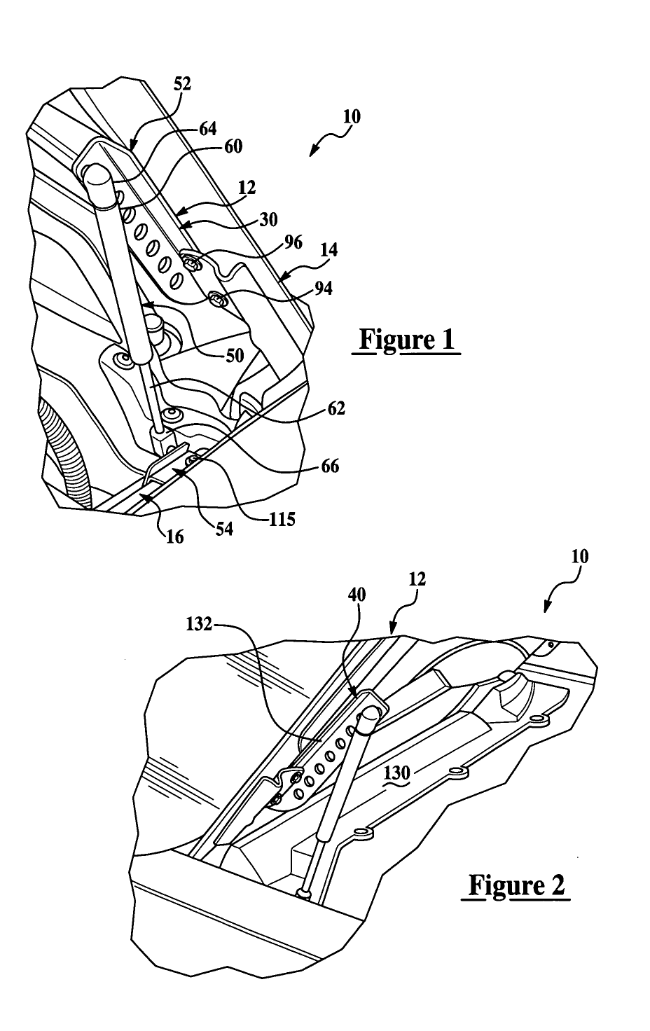

Referring to FIGS. 1 and 2, a vehicle 10 having a hood strut assembly kit 12 coupled between a vehicle hood 14 and a vehicle body 16 is provided. The hood strut assembly kit 12 is provided to maintain the hood 14 in an open operational position when a user lifts the hood 14 from a closed operational position to the open operational position. An advantage of the hood strut assembly kit 12 is that it can be installed on the vehicle 10 without the need for drilling holes in the kit 12 or in the vehicle 10, welding the kit 12, or utilizing pop rivets. Further, the hood strut assembly kit 12 can be easily removed from the vehicle 10. The hood strut assembly kit 12 includes a hood strut assembly 30 and a hood strut assembly 40.

Referring to FIG. 1, the hood strut assembly 30 is provided to maintain the vehicle hood 14 in the open operational position relative to the vehicle body 16 on a driver side of the vehicle 10. The hood strut assembly 30 includes a gas strut 50, a hood bracket 52, and a body bracket 54.

The gas strut 50 provides a biasing force to the hood bracket 52 coupled to the vehicle hood 14. The biasing force maintains the vehicle hood 14 in a raised operational position after the user has moved the vehicle hood 14 from the closed operational position to the open operational position. The gas strut 50 includes a housing 60, a piston 62, and attachment members 64, 66. The gas strut 50 further includes a biasing member (not shown) disposed in the housing 60 for biasing the piston 62, which is known to those skilled in the art. In particular, the piston 62 is biased outwardly from the housing 60 by the biasing member within the housing 60. The attachment member 64 is disposed on an end of the housing 60 and is configured to be rotatably coupled to a mounting member 92 of the hood bracket 52. The attachment member 66 is disposed on an end of the piston 62 and is configured to be rotatably coupled to a mounting member 119 of the body bracket 54.

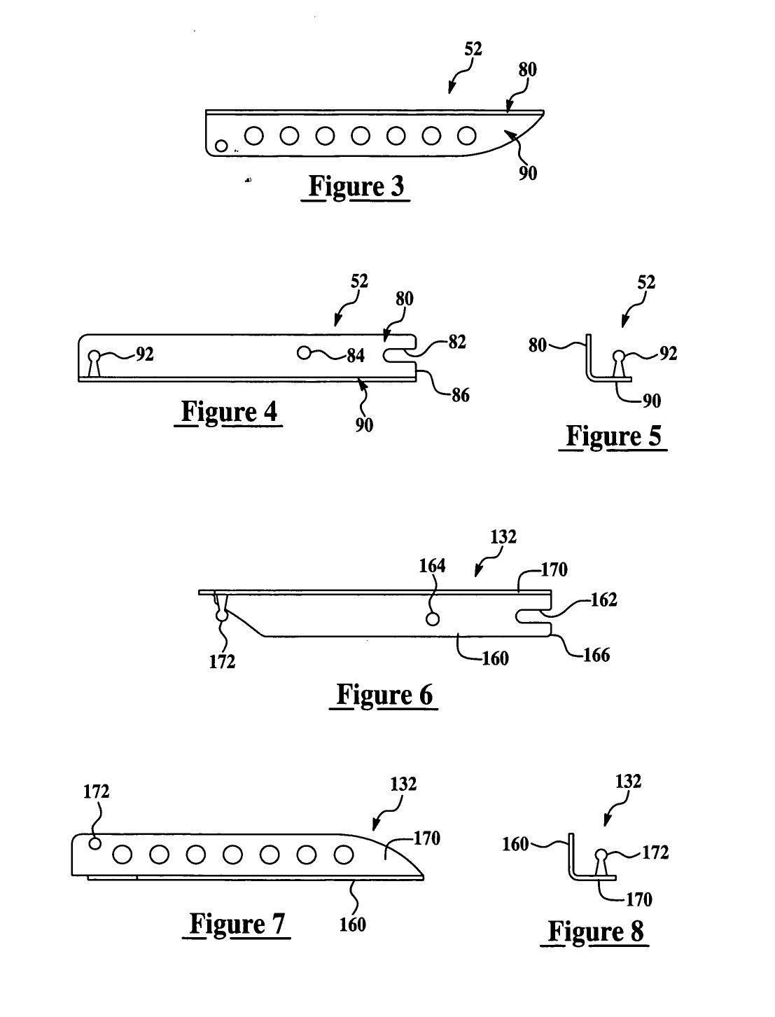

Referring to FIGS. 1 and 3-5, the hood bracket 52 is provided to be coupled between the vehicle hood 14 and the gas strut 50. The hood bracket 52 includes a plate portion 80, a plate portion 90, and a mounting member 93 such as a ball mount. The plate portions 80, 90 are constructed from steel. The plate portion 80 extends from the plate portion 90 such that a predetermined angle is formed between the plate portion 80 in the plate portion 90. In one exemplary embodiment, the predetermined angle between the plate portions 80, 90 is approximately 90 degrees. The plate portion 80 includes a slot 82 extending therethrough at an end 86. The slot 82 was configured to receive a fastener, such as a bolt 94 for example, therein for mounting the hood bracket 52 to the vehicle hood 14. During installation, the bolt 94 is partially loosened and is received in the slot 82 for coupling the hood bracket 52 to the vehicle hood 14, without having to first remove the bolt from the vehicle hood 14. The plate portion 80 further includes an aperture 84 extending therethrough for receiving a fastener, such as a bolt 96 for example, for further coupling the hood bracket 52 to the vehicle hood 14. The mounting member 92 is coupled to the plate portion 90 and is configured to rotatably coupled to the attachment member 64 of the gas strut 50.

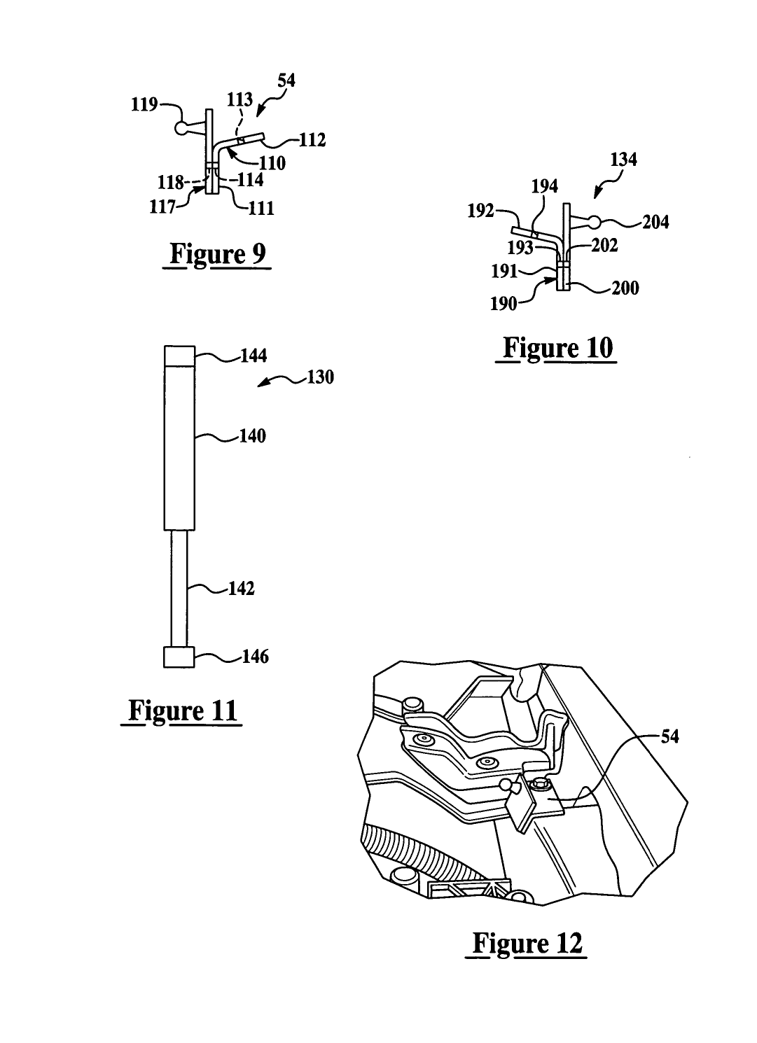

Referring to FIGS. 1 and 9, the body bracket 54 is provided to couple the gas strut 50 to the vehicle body 16. The body bracket 54 includes a plate portion 110, a plate portion 116, and a mounting member 118. The plate portion 110 includes a vertical portion 111 and a portion 112 extending away from the portion 111 at a predetermined angle. The plate portion 110 is configured to be disposed around edge of the vehicle body 16. The plate portion 110 includes an aperture 113 extending therethrough for receiving a fastener, such as a bolt 115, for coupling the body bracket 54 to the vehicle body 16. The plate portion 117 is disposed against the portion 111 of the plate portion 110. The plate portion 117 includes an aperture 118 extending therethrough that is aligned with the aperture 114. The apertures 114, 118 receive a fastener such as a bolt, for further coupling the body bracket 54 to the vehicle body 16. The mounting member 119 such as a ball mount is coupled to the plate portion 117 and extends in a direction substantially opposite of a direction of the portion 112. The ball mount 119 is configured to be rotatably coupled to the attachment member 66 of the gas strut 50.

Referring to FIG. 2, the hood strut assembly 40 is provided to maintain the vehicle hood 14 in the open operational position relative to the vehicle body 16 on a passenger side of the vehicle 10. The hood strut assembly 40 includes a gas strut 130, a hood bracket 132, and a body bracket 134.

Referring to FIGS. 2 and 11, the gas strut 130 provides a biasing force to the hood bracket 132 coupled to the vehicle hood 14. The biasing force maintains the vehicle hood 14 in a raised operational position after the user has moved the vehicle hood 14 from the closed operational position to the open operational position. The gas strut 130 includes a housing 140, a piston 142, and attachment members 144, 146. The gas strut 130 further includes a biasing member (not shown) disposed in the housing 140 for biasing the piston 142, which is known to those skilled in the art. In particular, the piston 142 is biased outwardly from the housing 140 by the biasing member within the housing 140. The attachment member 144 is disposed on an end of the housing 140 and is configured to be rotatably coupled to a mounting member 172 of the hood bracket 134. The attachment member 144 is disposed on an end of the piston 142 and is configured to be rotatably coupled to a mounting member 204 of the body bracket 134.

Referring to FIGS. 2 and 6-8, the hood bracket 134 is provided be coupled between the vehicle hood 14 and the gas strut 130. The hood bracket 134 includes a plate portion 160, a plate portion 170, and a mounting member 172 such as a ball mount for example. The plate portions 160, 170 are constructed from steel. The plate portion 160 extends from the plate portion 170 such that a predetermined angle is formed between the plate portion 160 and the plate portion 170. In one exemplary embodiment, the predetermined angle between the plate portions 160, 170 is approximately 90 degrees. The plate portion 160 includes a slot 162 extending therethrough at an end 166. The slot 162 is configured to receive a fastener, such as a bolt for example, therein for mounting the hood bracket 134 to the vehicle hood 14. During installation a hood bolt is partially loosened and is received in the slot 162 for coupling the hood bracket 134 to the vehicle hood 14, without having to first remove the bolt from the vehicle hood 14. The plate portion 160 further includes an aperture 164 extending therethrough for receiving a fastener, such as a bolt for example, for further coupling the hood bracket 134 to the vehicle hood 14. The mounting member 172 is coupled to the plate portion 170 and is configured to rotatably coupled to the attachment member 144 of the gas strut 130.

Referring to FIGS. 2 and 10, the body bracket 134 is provided to couple the gas strut 130 to the vehicle body 16. The body bracket 134 includes a plate portion 190, a plate portion 200, and a mounting member 204. The plate portion 190 includes a vertical portion 191 and a portion 192 extending away from the portion 191 at a predetermined angle. The plate portion 190 is configured to be disposed around edge of the vehicle body 16. The plate portion 190 includes an aperture 193 extending therethrough for receiving a fastener, such as a bolt for example, for coupling the body bracket 134 to the vehicle body 16. The plate portion 200 is disposed against the portion 191 of the plate portion 190. The plate portion 200 includes an aperture 202 extending therethrough that is aligned with the aperture 193. The apertures 193, 202 receive a fastener, such as a bolt for example, for further coupling the body bracket 134 to the vehicle body 16. The mounting member 204 such as a ball mount is coupled to the plate portion 200 and extends in a direction substantially opposite a direction of the portion 192. The ball mount 204 is configured to be rotatably coupled to the attachment member 146 of the gas strut 130.

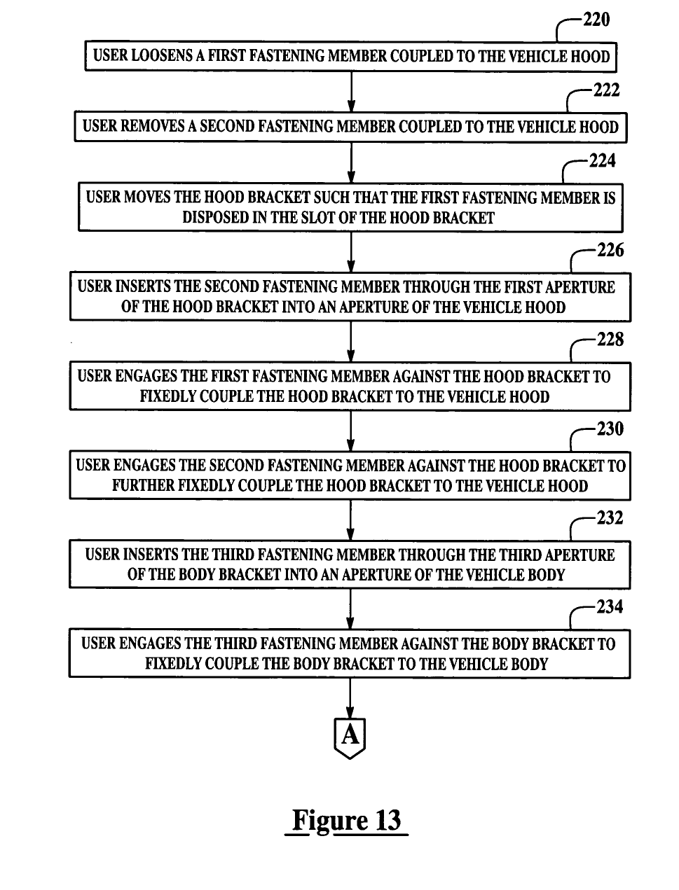

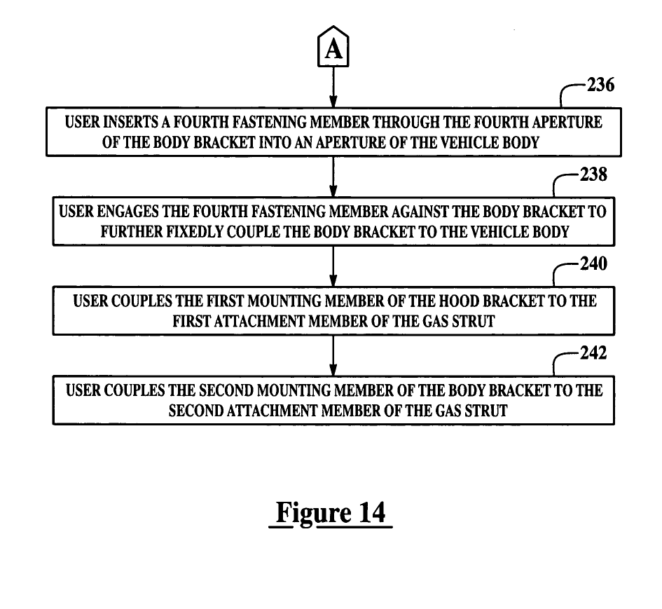

Referring to FIGS. 13-14, a method for mounting the hood strut assembly 30 to both the vehicle body 16 and the vehicle hood 14 will now be described. It should be noted that the hood strut assembly 40 can be mounted to the vehicle body 16 and the vehicle hood 14 in a substantially similar manner as the hood strut assembly 30.

At step 220, a user loosens the fastening member 94 coupled to the vehicle hood 14.

At step 222, the user removes the fastening member 96 coupled to the vehicle hood 14.

At step 224, the user moves the hood bracket 52 such that the fastening member 94 is disposed in the slot 82 of the hood bracket 52.

At step 226, the user inserts the fastening member 96 through the aperture 84 of the hood bracket 52 into an aperture of the vehicle hood 14.

At step 228, the user engages the fastening member 94 against the hood bracket 52 to fixedly couple the hood bracket 52 to the vehicle hood 14.

At step 230, the user engages the fastening member 96 against the hood bracket 52 to further fixedly couple the hood bracket 52 to the vehicle hood 14.

At step 232, the user inserts the fastening member 115 through the aperture 113 of the body bracket 54 into an aperture of the vehicle body 16.

At step 234, the user engages the fastening member 115 against the body bracket 54 to fixedly couple the body bracket 54 to the vehicle body 16.

At step 236, the user inserts another fastening member through the apertures 114, 118 of the body bracket 54 into an aperture of the vehicle body 16.

At step 238, the user engages the fastening member against the body bracket 54 to further fixedly couple the body bracket 54 to the vehicle body 16.

At step 240, the user couples the mounting member 92 of the hood bracket 52 to the attachment member 64 of the gas strut 50.

At step 242, the user couples the mounting member 119 of the body bracket to the attachment member 66 of the gas strut 50. After step 242, the method is ended.

The hood strut assembly and the method for mounting the hood strut assembly to both a vehicle body and a vehicle hood represents a substantial advantage over other assemblies and methods. In particular, the hood strut assembly provides technical effect of allowing a hood bracket to be easily coupled to a vehicle hood by utilizing a slot that can be easily received over an existing bolt of the vehicle hood, without removing the bolt from the vehicle hood.

While embodiments of the invention are described with reference to the exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another. Furthermore, the use of the terms a, an, etc. do not denote a limitation of quantity, but rather denote the presence of at least one of the referenced items.

What is claimed is:

1. A hood strut assembly, comprising:
a gas strut having a housing, a piston extending from the housing, and first and second attachment members, the first attachment member coupled to the housing, the second attachment member coupled to an end of the piston;
a hood bracket having first and second plate portions and a first mounting member, the first plate portion extending from the second plate portion such that a predetermined angle is formed between the first plate portion and the second plate portion, the first plate portion having an end with a slot extending therethrough, the first plate portion further having a first aperture extending therethrough, the first aperture configured to receive a first fastener therethrough for coupling the hood bracket to a vehicle hood and the first slot configured to receive a second fastener therethrough for further coupling the hood bracket to the vehicle hood, the first mounting member of the hood bracket being coupled to the first attachment member of the gas strut; and
a body bracket configured to be coupled to a vehicle body, the body bracket having a second mounting member coupled to the second attachment member of the gas strut.

2. The hood strut assembly of claim 1, wherein the body bracket further comprises a third plate portion, a fourth plate portion, the third plate portion configured to be disposed around an edge of a vehicle body member, the fourth plate portion being disposed against a portion of the third plate portion, the second mounting member extending from the fourth plate portion and being attached to the second attachment member coupled to the piston.

3. A hood strut assembly kit, comprising:
a first hood strut assembly having a first gas strut, a first hood bracket, and a first body bracket, the first gas strut having a first housing, a first piston extending from the first housing, and first and second attachment members, the first attachment member coupled to the first housing, the second attachment member coupled to an end of the first piston;
the first hood bracket having first and second plate portions and a first mounting member, the first plate portion extending from the second plate portion such that a predetermined angle is formed between the first plate portion and the second plate portion, the first plate portion having an end with a first slot extending therethrough, the first plate portion further having a first aperture extending therethrough, the first aperture configured to receive a first fastener therethrough for coupling the first hood bracket to a vehicle hood and the first slot configured to receive a second fastener therethrough for further coupling the first hood bracket to the vehicle hood, the first mounting member of the first hood bracket being coupled to the first attachment member of the first gas strut;
the first body bracket configured to be coupled to a vehicle body, the first body bracket having a second mounting member coupled to the second attachment member of the first gas strut;
a second hood strut assembly having a second gas strut, a second hood bracket, and a second body bracket, the second gas strut having a second housing, a second piston extending from the second housing, and third and fourth attachment members, the third attachment member coupled to the second housing, the fourth attachment member coupled to an end of the first piston;
the second hood bracket having third and fourth plate portions and a third mounting member, the third plate portion extending from the fourth plate portion such that a second predetermined angle is formed between the third plate portion and the fourth plate portion, the third plate portion having an end with a second slot extending therethrough, the third plate portion further having a second aperture extending therethrough, the second aperture configured to receive a third fastener therethrough for coupling the hood bracket to the vehicle hood and the second slot configured to receive a fourth fastener therethrough for further coupling the second hood bracket to the vehicle hood, the third mounting member of the second hood bracket being coupled to the third attachment member of the second gas strut; and
the second body bracket configured to be coupled to the vehicle body, the second body bracket having a fourth mounting member coupled to the fourth attachment member of the second gas strut.

4. A method for mounting a hood strut assembly to both a vehicle body and a vehicle hood, the hood strut assembly having a gas strut, a hood bracket, and a body bracket, the gas strut having a housing, a piston extending from the housing, and first and second attachment members, the first attachment member coupled to the housing, the second attachment member coupled to an end of the piston, the hood bracket having first and second plate portions and a first mounting member, the first plate portion extending from the second plate portion such that a predetermined angle is formed between the first plate portion and the second plate portion, the first plate portion having an end with a slot extending therethrough, the first plate portion further having a first aperture extending therethrough, the body bracket having a second mounting member, the method comprising:
loosening a first fastening member coupled to the vehicle hood;
removing a second fastening member coupled to the vehicle hood;
moving the hood bracket such that the first fastening member is disposed in the slot of the hood bracket;
inserting the second fastening member through the first aperture of the hood bracket into an aperture of the hood;
engaging the first fastening member against the hood bracket to fixedly couple the hood bracket to the vehicle hood;
engaging the second fastening member against the hood bracket to further fixedly coupled the hood bracket to the vehicle hood;
inserting the third fastening member through the third aperture of the body bracket into an aperture of the vehicle body;
engaging the third fastening member against the body bracket to fixedly couple the body bracket to the vehicle body;
coupling the first mounting member of the hood bracket to the first attachment member of the gas strut; and
coupling the second mounting member of the body bracket to the second attachment member of the gas strut.
